(19) United States
(12) Patent Application Publication
(10) Pub. No.: US 2026/0365279 A1
(43) Pub. Date: Nov. 19, 2026

(54) BICYCLE OPERATING DEVICE

(71) Applicant: AD-II Engineering Inc., Taichung City (TW)

(72) Inventors: MENG-SIAN HUANG, Taichung City (TW); CHUNG-REN CHANG, Taichung City (TW); JYUN-HUA LIN, Taichung City (TW)

(21) Appl. No.: 19/208,992

(22) Filed: May 15, 2025

(51) Int. Cl. B62M 25/08

(52) U.S. Cl. CPC B62M 25/08

(57) ABSTRACT

A bicycle operating device is provided, wherein the bicycle operating device includes: a base member configured to be mounted to a handlebar of a bicycle; a brake member rotatably connected to the base member by a shaft, the shaft defining a rotation axis; a control member rotatably connected to the shaft; a circuit unit; a power supply unit disposed on the control member and electrically connected to the circuit unit; and an operation member including at least one pressing unit and being configured to trigger the circuit unit to generate a signal by operating the pressing unit.

### BACKGROUND OF THE INVENTION

### Field of the Invention

The present invention relates to a bicycle component, particularly to a bicycle operating device.

### Description of the Prior Art

With the advancement of bicycle technologies, especially in the field of high-performance and competitive bicycles, electronic shifting systems have gradually begun to replace traditional mechanical shifting systems. Electronic shifting uses electronic signals to perform gear changes and is capable of automatic adjustment, thereby providing a more stable shifting experience.

In the bicycle operating devices of conventional technologies, shifting buttons are typically disposed on the brake lever, which may easily result in erroneous operations during emergency braking or rapid shifting. For example, a rider may accidentally pull the brake while operating the shifter, leading to unintended braking that affects riding safety. In addition, circuit units are often disposed inside the brake member, making it easy to accidentally touch the brake during gear shifting and thereby increasing the safety risk.

Furthermore, in conventional bicycle operating devices, the battery is typically disposed inside the base member, which is mounted to the handlebar of the bicycle. As a result, different base member specifications require retooling due to battery placement requirements, thereby increasing manufacturing cost.

The present invention is, therefore, arisen to obviate or at least mitigate the above-mentioned disadvantages.

### SUMMARY OF THE INVENTION

The main object of the present invention is to provide a bicycle operating device whose power supply unit is disposed on the control member, so that it is not necessary to modify or damage the existing base member design, making removal and replacement easier and enabling compatibility with existing handlebar structures.

To achieve the above and other objects, a bicycle operating device is provided, wherein the bicycle operating device includes: a base member configured to be mounted to a handlebar of a bicycle; a brake member rotatably connected to the base member by a shaft, the shaft defining a rotation axis; a control member rotatably connected to the shaft; a circuit unit; a power supply unit disposed on the control member and electrically connected to the circuit unit; and an operation member including at least one pressing unit and being configured to trigger the circuit unit to generate a signal by operating the pressing unit.

To achieve the above and other objects, a bicycle operating device is provided, wherein the bicycle operating device includes: a base member configured to be mounted to a handlebar of a bicycle; a brake member rotatably connected to the base member by a shaft, the shaft defining a rotation axis; a control member rotatably connected to the shaft; a circuit unit; a power supply unit disposed on the control member and electrically connected to the circuit unit; and an operation member disposed on the brake member, the operation member including at least one pressing unit and being configured to trigger the circuit unit to generate a signal by operating the pressing unit.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a first exemplary embodiment of the present invention;

FIG. 2 is an exploded view of the first exemplary embodiment of the present invention;

FIG. 3 is another exploded view of the first exemplary embodiment of the present invention;

FIG. 4 is a schematic view of the first exemplary embodiment of the present invention as viewed in a direction along the rotation axis;

FIG. 5 is yet another exploded view of the first exemplary embodiment of the present invention;

FIG. 6 is a cross-sectional view of the first exemplary embodiment of the present invention;

FIG. 7 is a partial front view of the first exemplary embodiment of the present invention;

FIG. 8 is a partial side view of the first exemplary embodiment of the present invention; and

FIG. 9 is an exploded view of a second exemplary embodiment of the present invention.

### DETAILED DESCRIPTION OF THE PREFERRED EMBODIMENTS

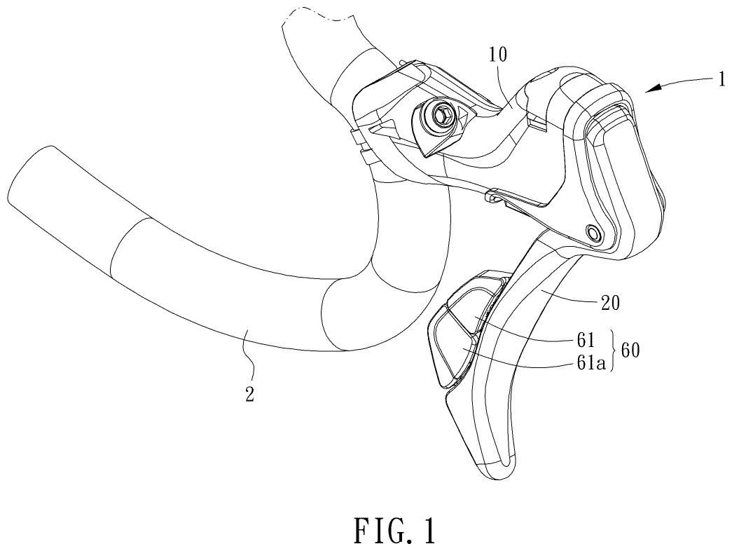

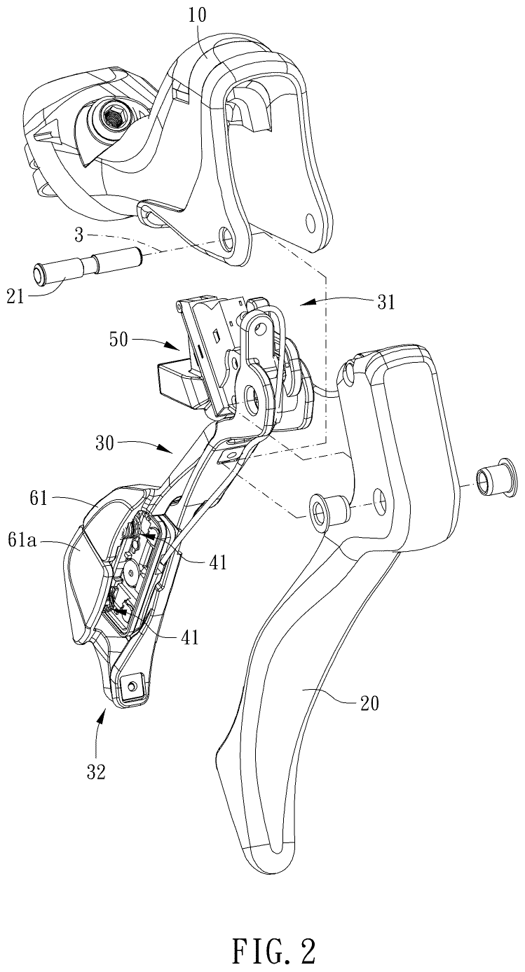

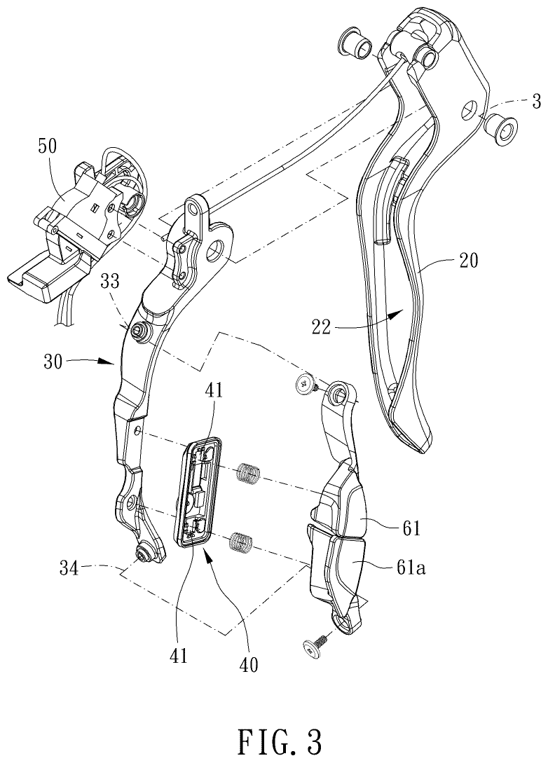

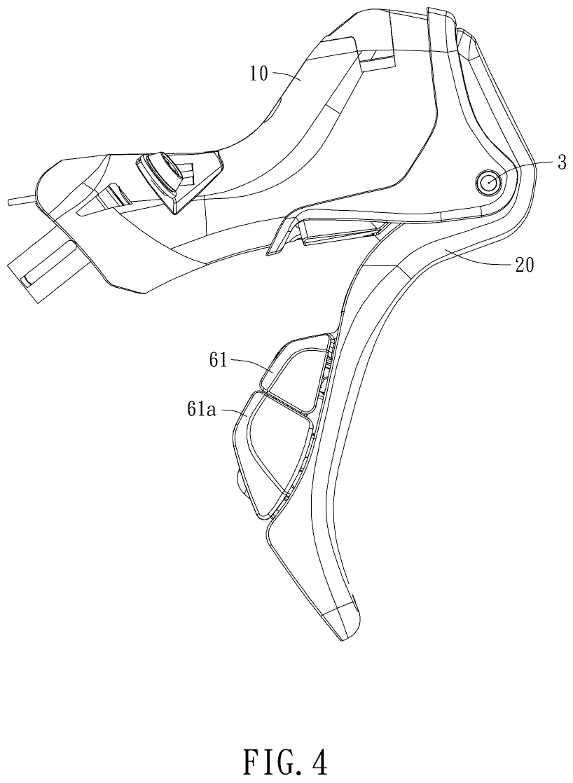

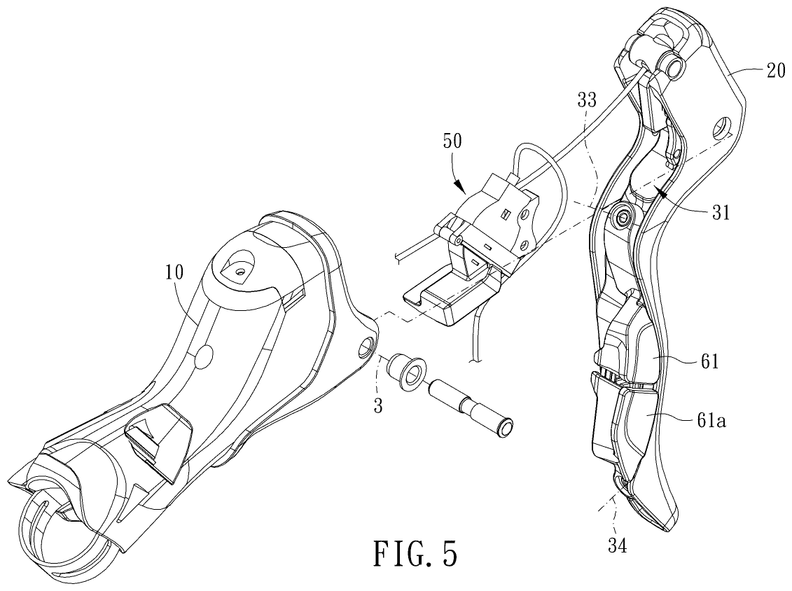

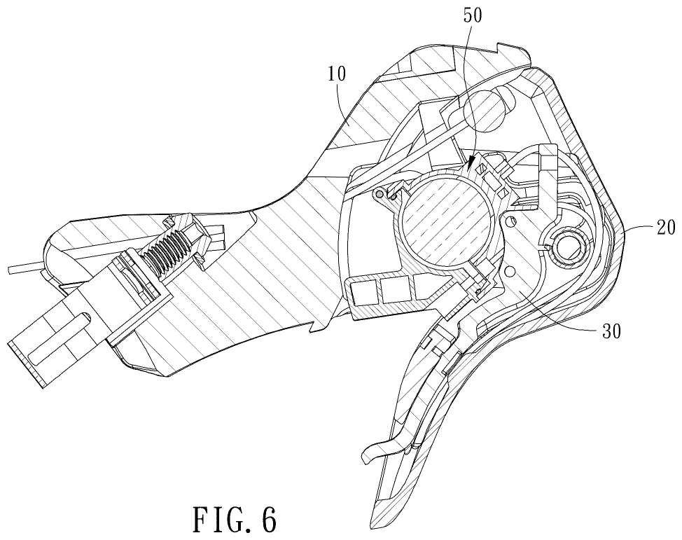

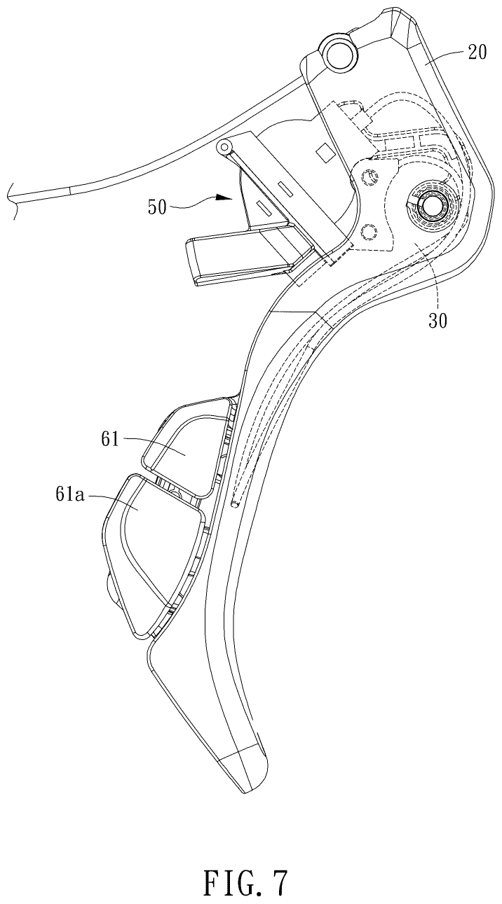

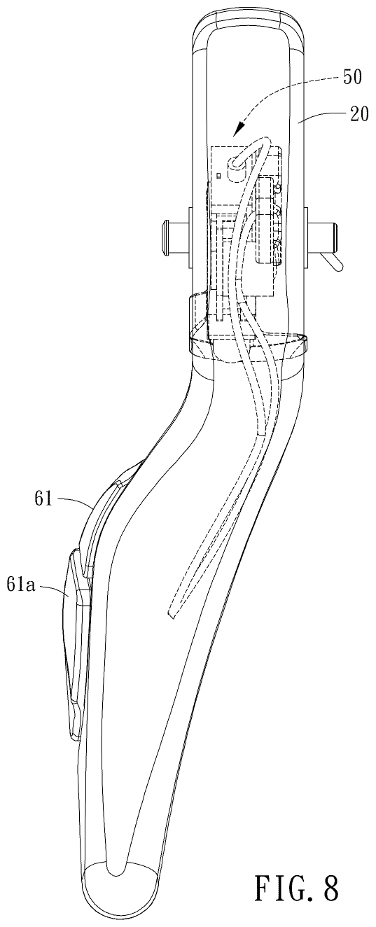

Please refer to FIGS. 1 to 8 for an exemplary embodiment of the present invention. A bicycle operating device 1 of the present invention includes a base member 10, a brake member 20, a control member 30, a circuit unit 40, a power supply unit 50 and an operation member 60.

The base member 10 is configured to be mounted to a handlebar 2 of a bicycle. The brake member 20 is rotatably connected to the base member 10 by a shaft 21, and the shaft 21 defines a rotation axis 3. The brake member 20 is rotatable about the rotation axis 3 relative to the base member 10. The control member 30 is rotatably connected to the base member 10. The control member 30 includes a first end portion 31 adjacent to the rotation axis 3 and a second end portion 32 remote from the rotation axis 3. Specifically, the shaft 21 is disposed through the base member 10, the brake member 20 and the control member 30.

The circuit unit 40 is disposed on the control member 30. Preferably, the circuit unit 40 is disposed on the control member 30 and is located closer to the second end portion 32 than to the first end portion 31. The operation member 60 is disposed on the control member 30. The operation member 60 includes at least one pressing unit and is configured to trigger the circuit unit 40 to generate a signal by operating the pressing unit. In this embodiment, the circuit unit 40 includes at least one electric switch 41. The at least one electric switch 41 (i.e., the pressing unit) is triggered by the operation member 60 to drive the circuit unit 40 to generate the signal. The number of electric switches 41 corresponds to the number of pressing units.

The power supply unit 50 (e.g., including a battery) is disposed on the control member 30 and is electrically connected to the circuit unit 40. Preferably, the power supply unit 50 is disposed on the control member 30 and is located closer to the first end portion 31 than to the second end portion 32.

As such, the user can avoid accidentally triggering the at least one electric switch 41, and the configuration of the power supply wiring becomes more convenient and space-saving. Moreover, the installation and maintenance of the circuit unit 40 and the power supply unit 50 are also facilitated. In addition, because the power supply unit 50 is disposed on the control member 30, different styles of base members 10 can be used, thereby improving product compatibility and modularity and reducing production and maintenance costs.

Specifically, the at least one pressing unit includes a first pressing unit 61 and a second pressing unit 61a. The first pressing unit 61 is rotatably connected to the control member 30 and rotatable about a first pivot axis 33. In this embodiment, the first pressing unit 61 is rotatably connected to a second pivoting structure of the control member 30 by a first pivoting structure. The first pivoting structure defines the first pivot axis 33. The first pressing unit 61 is rotatable about the first pivot axis 33 relative to the control member 30. The second pressing unit 61a is rotatably connected to the control member 30 and rotatable about a second pivot axis 34. In this embodiment, the second pressing unit 61a is rotatably connected to a fourth pivoting structure of the control member 30 by a third pivoting structure. The fourth pivoting structure defines the second pivot axis 34. The second pressing unit 61a is rotatable about the second pivot axis 34 relative to the control member 30. The first pivot axis 33 is located closer to the first end portion 31 than to the second end portion 32; the second pivot axis 34 is located closer to the second end portion 32 than to the first end portion 31. As such, the first pressing unit 61 and the second pressing unit 61a can trigger the circuit unit 40 with small force, allowing for smooth operation at various angles.

Specifically, the brake member 20 includes a recess 22, and the control member 30 is at least partially received within the recess 22, thereby ensuring close contact between the control member 30 and the brake member 20.

Preferably, as viewed in a direction along the rotation axis 3, the first pivot axis 33 is located above the first pressing unit 61, and the second pivot axis 34 is located below the second pressing unit 61a. In this embodiment, as viewed in a direction along the rotation axis 3, the first pressing unit 61 and the second pressing unit 61a are arranged in a high-low manner along the control member 30. It is noted that the control member 30 and the brake member 20 are at least partially overlapped, and the first pressing unit 61 and the second pressing unit 61a are sequentially arranged in a high-low manner along the brake member 20. As such, the user's fingers need only make a small movement for pressing without affecting the operation of the brake member 20.

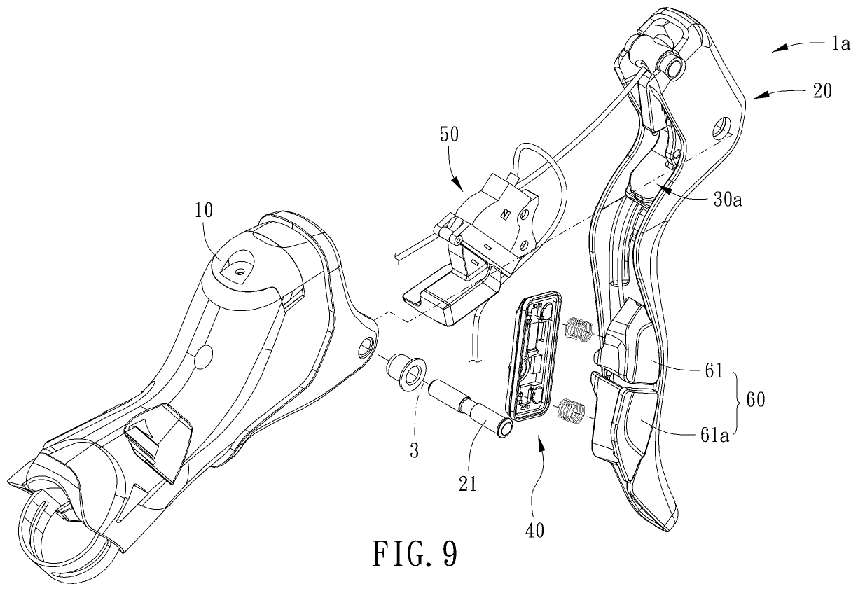

Please refer to FIG. 9 which illustrates a second exemplary embodiment of the present invention. In this embodiment, the base member 10 of the bicycle operating device 1a is configured to be mounted to the handlebar of the bicycle. The brake member 20 is rotatably connected to the base member 10 by a shaft 21, and the shaft 21 defines a rotation axis 3. The control member 30a is rotatably connected to the shaft 21. The power supply unit 50 is disposed on the control member 30a and electrically connected to the circuit unit 40. The operation member 60 is disposed on the brake member 20 and includes at least one pressing unit 61, 61a. The circuit unit 40 is configured to generate a signal by operating the pressing unit 61 or 61a, thereby providing convenient operation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bicycle operating device including:
a base member configured to be mounted to a handlebar of a bicycle;
a brake member rotatably connected to the base member by a shaft, the shaft defining a rotation axis;
a control member rotatably connected to the shaft;
a circuit unit;
a power supply unit disposed on the control member and electrically connected to the circuit unit; and
an operation member including at least one pressing unit and being configured to trigger the circuit unit to generate a signal by operating the pressing unit.

2. The bicycle operating device of claim 1, wherein the control member includes a first end portion adjacent to the rotation axis and a second end portion remote from the rotation axis.

3. The bicycle operating device of claim 2, wherein the circuit unit is disposed on the control member and is located closer to the second end portion than to the first end portion.

4. The bicycle operating device of claim 2, wherein the power supply unit is disposed on the control member and is located closer to the first end portion than to the second end portion.

5. The bicycle operating device of claim 1, wherein the circuit unit includes at least one electric switch, and the at least one electric switch is triggered by the operation member to drive the circuit unit to generate the signal.

6. The bicycle operating device of claim 2, wherein the at least one pressing unit includes a first pressing unit and a second pressing unit, the first pressing unit is rotatably connected to the control member and rotatable about a first pivot axis, the second pressing unit is rotatably connected to the control member and rotatable about a second pivot axis, the first pivot axis is located closer to the first end portion than to the second end portion, and the second pivot axis is located closer to the second end portion than to the first end portion.

7. The bicycle operating device of claim 6, wherein as viewed in a direction along the rotation axis, the first pressing unit and the second pressing unit are arranged in a high-low manner and extend along the control member.

8. The bicycle operating device of claim 6, wherein as viewed in a direction along the rotation axis, the first pivot axis is located above the first pressing unit, and the second pivot axis is located below the second pressing unit.

9. The bicycle operating device of claim 1, wherein the brake member includes a recess, and the control member is received within the recess.

10. A bicycle operating device including:
a base member configured to be mounted to a handlebar of a bicycle;
a brake member rotatably connected to the base member by a shaft, the shaft defining a rotation axis;
a control member rotatably connected to the shaft;
a circuit unit;
a power supply unit disposed on the control member and electrically connected to the circuit unit; and
an operation member disposed on the brake member, the operation member including at least one pressing unit and being configured to trigger the circuit unit to generate a signal by operating the pressing unit.
